(19) United States
(12) Patent Application Publication
(10) Pub. No.: US 2018/0319283 A1
(43) Pub. Date: Nov. 8, 2018

(54) Aircraft Power System

(71) Applicant: Bell Helicopter Textron Inc., Fort Worth, TX (US)

(72) Inventors: Aditya Battin, Bangalore (IN); Phalgun Madhusudan, Bangalore (IN); Bharatesh Kalasur, Bangalore (IN)

(73) Assignee: Bell Helicopter Textron Inc., Fort Worth, TX (US)

(21) Appl. No.: 15/589,876

(22) Filed: May 8, 2017

(51) Int. Cl. B60L 11/00; B60L 11/18; B60K 1/02; B60K 1/04; B64C 27/12; B64C 27/82

(52) U.S. Cl. CPC B60L 11/005; B60L 11/18; B60K 1/02; B60K 2001/0416; B64C 27/12; B64C 27/82; B60L 2200/10; B60K 1/04

(57) ABSTRACT

An aircraft has a fuel cell, a battery configured to be charged by the fuel cell, a supercapacitor configured to be charged by the fuel cell, and a power management unit configured to receive electrical power from the fuel cell, the battery, and the supercapacitor.

### BACKGROUND

Aircraft, such as, but not limited to, helicopters, typically utilize petroleum based fuels to fuel combustion engines. However, typical combustion engines are inefficient and account for a significant amount of energy loss from tank-to-wing (TTW). Accordingly, alternative fuels and power sources have been considered for rotorcraft and other vehicles. In some cases, fuel cells and associated batteries have been utilized in vehicles to replace or supplement conventional combustion engines.

### BRIEF DESCRIPTION OF THE DRAWINGS

FIG. 1 is an orthogonal left side view of a helicopter according to an embodiment of this disclosure.

FIG. 2 is a schematic depiction of a power system of the helicopter of FIG. 1.

FIG. 3 is a schematic depiction the power system of FIG. 2 according to another embodiment.

FIG. 4 is a flowchart of a method of powering a rotor system of a rotorcraft according to an embodiment of this disclosure.

### DETAILED DESCRIPTION

In the specification, reference may be made to the spatial relationships between various components and to the spatial orientation of various aspects of components as the devices are depicted in the attached drawings. However, as will be recognized by those skilled in the art after a complete reading of the present disclosure, the devices, members, apparatuses, etc. described herein may be positioned in any desired orientation. Thus, the use of terms such as “above,” “below,” “upper,” “lower,” or other like terms to describe a spatial relationship between various components or to describe the spatial orientation of aspects of such components should be understood to describe a relative relationship between the components or a spatial orientation of aspects of such components, respectively, as the device described herein may be oriented in any desired direction.

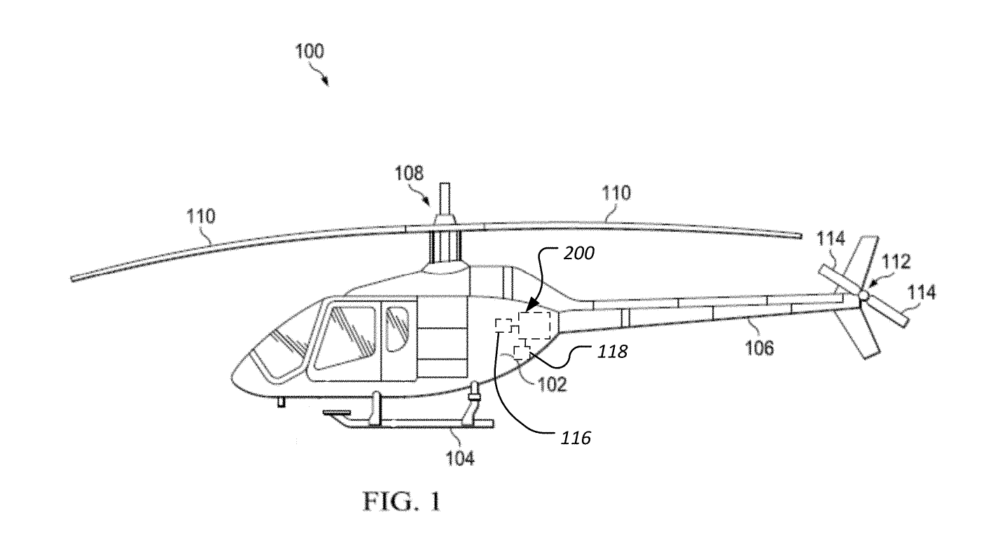

Referring to FIG. 1 in the drawings, a helicopter 100 is illustrated. Helicopter 100 can include a fuselage 102, a landing gear 104, a tail member 106, a main rotor system 108 comprising main rotor blades 110, and a tail rotor system 112 comprising tail rotor blades 114. The main rotor blades 110 and the tail rotor blades 114 can be rotated and selectively controlled in order to selectively control direction, thrust, and lift of helicopter 100. In this embodiment, the helicopter 100 further comprises an electric motor 116 configured to receive electrical power from a power system 200. In this embodiment, the electric motor 116 is configured to drive the main rotor system 108 to selectively move the main rotor blades 110. In alternative embodiments, additional electrical motors can be powered by the power system 200 to selectively drive the tail rotor system 112 to selectively move the tail rotor blades 114. In some cases, the main rotor system 108 and/or the tail rotor system 112 can be referred to as propulsion systems of the helicopter 100.

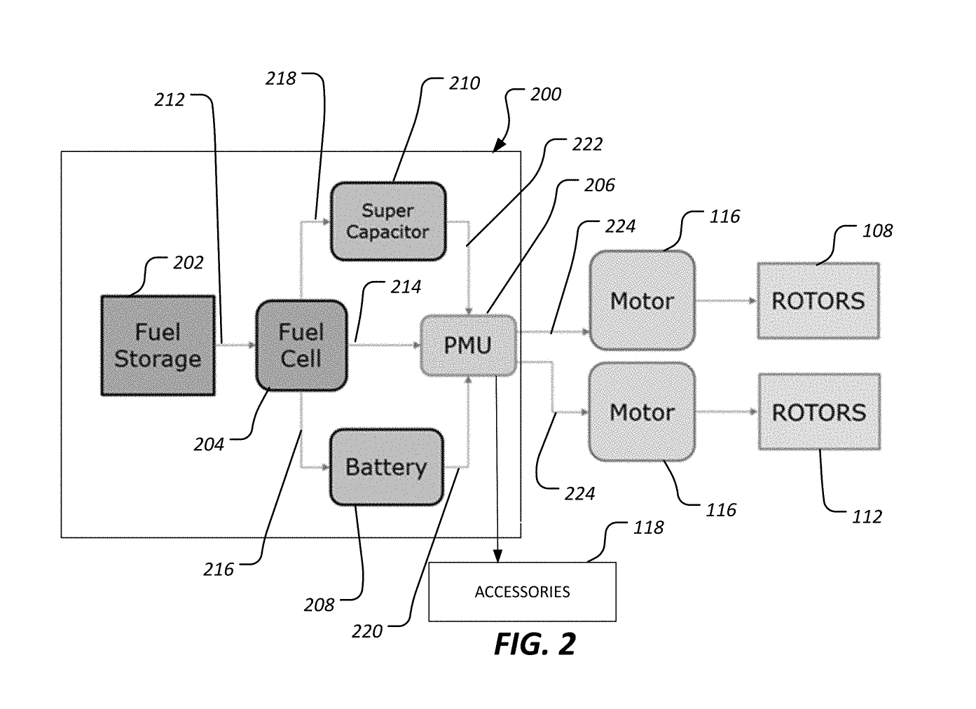

Referring now to FIG. 2 in the drawings, a schematic depiction of the power system 200 is shown. The power system 200 most generally comprises a fuel storage 202, a fuel cell 204, a power management unit 206, a battery 208, and a supercapacitor 210. The fuel storage 202 comprises any suitable tank, bag, and/or other reservoir capable of receiving and storing fluid fuel for the fuel cell 204. The fuel storage 202 is connected to the fuel cell 204 by a fuel conduit 212 configured to allow fluid communication between the fuel storage 202 and the fuel cell 204. In some embodiments, the fuel cell 204 comprises a proton exchange membrane and is configured to combust ethanol and to output electrical energy. In alternative embodiments, the fuel cell 204 is configured to combust other fuels, such as, but not limited to, hydrogen. At least some of the electrical energy generated by the fuel cell 204 can be delivered to the power management unit 206 via a direct output conduit 214 connecting the fuel cell 204 to the power management unit 206. Additionally, at least some of the electrical energy generated by the fuel cell 204 can be delivered to the battery 208 and/or the supercapacitor 210 via a battery input conduit 216 and a capacitor input conduit 218, respectively. The power management unit 206 is also generally configured to selectively receive electrical power from the battery 208 via a battery output conduit 220 and/or from the supercapacitor 210 via a capacitor output conduit 222. In this embodiment, the power management unit 206 can condition electrical power received and deliver electrical energy via a motor power conduit 224 to one or more electrical actuators, such as but not limited to electrical motors 116. The electrical motors Most generally, the power management unit 206 comprises power electronics necessary to condition power, switch between power outputs, dissipate power, and/or otherwise selectively direct electrical power to other components. While the power system 200 is described above as providing electrical power to motors 116, in alternative embodiments, the power system 200 can be configured to provide electrical power to any other at least partially electrically powered propulsion system for an aircraft and/or other vehicle or device.

In some embodiments, the use of the fuel cell 204 to power one or more propulsion systems (such as the main rotor system 108 and/or the tail rotor system 112) reduces the power requirements of any internal combustion engine and/or gas turbines as propulsion power sources. In some cases, the helicopter 100 can be fully powered by the power system 200 so that no internal combustion engine and/or gas turbines are needed for propulsion. In some cases, the high specific energy of the proton exchange membrane fuel cells such as the fuel cell 204 can extend the range of the helicopter as compared to a substantially similar helicopter that utilizes an internal combustion engine and/or gas turbines.

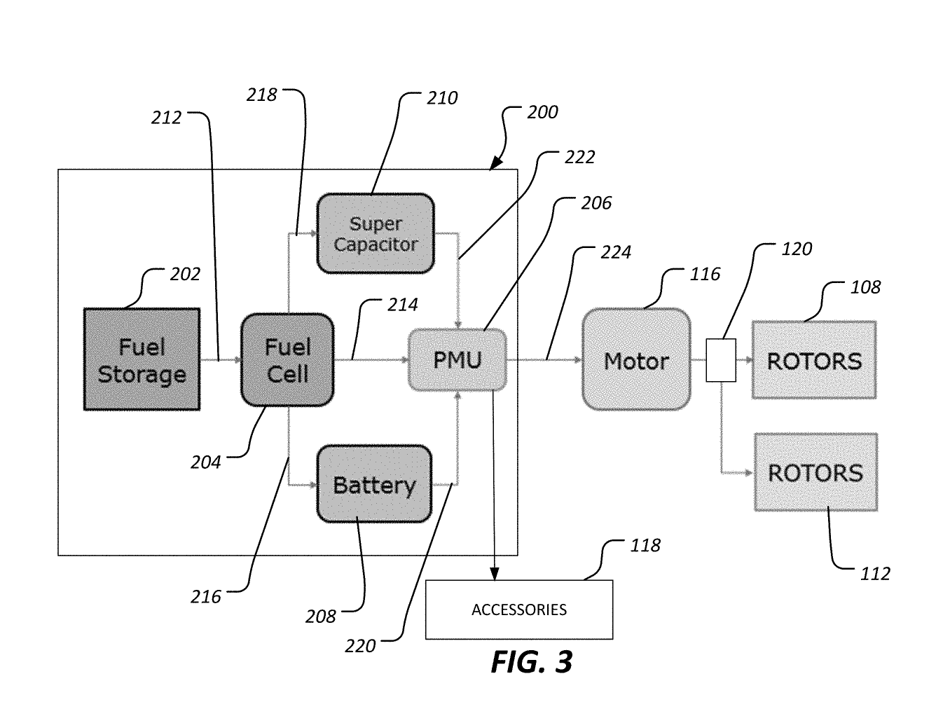

In this embodiment, the fuel cell 204 is configured to combust ethanol and to provide substantially continuous operational electrical power output. The power management unit 206 is configured to draw power from at least one of the fuel cell 204, the battery 208, and the supercapacitor 210 and feed the electrical power to the electrical motors 116 and/or any other electrical motor configured to assist with propulsion of the helicopter 100. As compared to hydrogen and other fuel cell fuels, ethanol is easily available and the required transportation infrastructure for ethanol delivery and storage is already in place. However, advances in collection, generation, storage, and/or management of hydrogen are contemplated which make hydrogen a viable source of fuel for a fuel cell in a rotorcraft. In some embodiments, the electrical motors 116 comprise brushless direct current motors. In this embodiment, the motors 116 are configured to drive more than one rotor system, namely, main rotor system 108 and tail rotor system 112. In this embodiment, each motor 116 is configured to drive a single rotor system. In alternative embodiment, the rotor systems driven by the motors 116 may not be a main rotor system and a tail rotor system, but instead, may comprise multiple main rotor systems (in the case where a helicopter comprises two independently driven main rotor systems) or any combination of types of rotor systems. In some cases, driving multiple rotor systems using a single electric motor 116 can be accomplished by utilizing rotational power splitting devices and/or a transmission 120 (see FIG. 3).

Referring now to FIG. 3, the power system 200 is shown configured to power a single electric motor 116 that drives two rotors systems through the use of a transmission 120. As stated above, in alternative embodiments, the single electric motor 116 of FIG. 3 may be configured to power two main rotor systems rather than a main rotor system 108 and a tail rotor system 112.

In some cases, the battery 208 and the supercapacitor 210 are charged when the power management unit 206 is supplied more electrical power than needed to power the motors 116. In some cases, the battery 208 and the supercapacitor 210 continually draw electrical power from the fuel cell 204 until fully charged. In operation, while the power supplied directly to the power management unit 206 from the fuel cell 204 may normally supply all power needed to the motors 116, the power management unit 206 can receive additional power from the battery 208 and/or the supercapacitor 210 when needed for aircraft operations requiring higher power. In some cases, power may instead or additionally be drawn from the battery 208 and/or the supercapacitor 210 when conducting high load operations such as, but not limited to, climbing and/or taking off. The amount of electrical power provided to the motors 116 from each of the sources (fuel cell 204, battery 208, and supercapacitor 210) is determined by the power management unit 206. In some cases, the power management unit 206 is configured to supply at least some extraneous electrical power to accessories 118 of the helicopter 100. The accessories 118 can comprise internal and external lighting, communications equipment, avionics systems, and/or any other device or system that can be electrically powered. In some cases, the battery 208 comprises a zinc/air type battery, a solid state type battery, and/or a lithium-ion type battery, however, it is contemplated that the battery 208 can comprise any other suitable materials and/or structure.

In some cases, the battery 208 comprises at least one of lithium ion, lithium manganese oxide, zinc-carbon, zinc-chloride, alkaline, and further can comprise one or more of zinc manganese dioxide, nickel oxyhydroxide, lithium copper oxide, a bio-battery, lithium iron disulfide, lithium chromium oxide, lithium carbon fluoride, mercury oxide, zinc-air, silver-oxide, silver-zinc, magnesium, a Zamboni pile, nickel cadmium, nickel metal hydride, nickel zinc, silver zinc, lithium iron phosphate, and a solid state battery.

In some cases, the supercapacitor 210 comprises a polyaniline/graphene construction, however, it is contemplated that the supercapacitor 210 can comprise any other suitable materials and/or structure. In some embodiments, the supercapacitor 210 can comprise any of an electric double layer capacitor, a hybrid capacitor, a pseudo capacitor, a bio supercapacitor, and a fullerene supercapacitor. In some cases, the supercapacitor comprises an electrode comprising at least one of polyaniline, gold, aluminum, platinum, palladium, activated carbon, graphite, graphene, graphane, carbon nanotubes, carbide derived carbon, carbon aerogel, manganese, ruthenium, iridium, iron, titanium (sulfide), composite electrodes, lithium, sulfuric acid, potassium hydroxide, sodium perchlorate, lithium perchlorate, phosphonium salts, lithium hexafluoro arsenate, acetonitrile, propylene carbonate, polyacrylonitrile, chitin, lignin, pectin, cellulose, polymers of pyran, and furan.

While the fuel cell 204 can be any type of fuel cell, it is contemplated that 40%-50% efficiency is achievable utilizing the an ethanol-fueled fuel cell. It is further contemplated that even greater efficiency can be obtained by utilizing an ethanol-fueled fuel cell comprising nanoparticle catalysts. For example, a non-platinum carbon-based catalyst can be employed as an anode catalyst in fuel cells fed with ethanol. Alternatively and/or additionally, a non-precious metal carbon-based cathode catalyst can be used in direct alcohol fuel cells where ethanol is fed directly into the fuel cell. One supplier of such nanoparticle catalyst technology is Acta S.p.A. of Via di Lavoria, 56/G—56040, Crespina (PI), Italy. In particular, Acta provides a catalyst, HYPERMEC, that is based on non-noble metals, mixtures of Fe, Co, and Ni at the anode and Ni, Fe, and Co at the cathode. The catalyst generally comprises tiny metal particles that are fixed onto a substrate so that they produce a very active catalyst that is free of platinum and can be mass produced at low cost. The above-described catalysts can be active below freezing, compatible with ethylene glycol as fuel, and are stable up to 800 degrees Celsius. In some cases, the catalysts are not affected by fuel cross-overs and can work with novel substrate stack designs. The above-described catalysts can contribute to generation of comparable power to conventional Pt—Re catalysts and with ethanol as the fuel, surface power densities as high as 140 mW/cm2 at 0.5V can be obtained at 25 degrees Celsius. In alternative embodiments, enzymatic biocatalysts may be utilized in addition to and/or instead of the above-described catalysts.

In some embodiments, the fuel cell 204 can comprise at least one of a microbial fuel cell, metal hydride fuel cell, electro-galvanic fuel cell, a direct formic acid fuel cell, a polymer membrane regenerative fuel cell, a direct borohydride fuel cell, an alkaline fuel cell, a direct or reformed methanol fuel cell, a direct ethanol fuel cell, a proton exchange membrane fuel cell, a redox fuel cell, a phosphoric acid fuel cell, a solid acid fuel cell, a molten carbonate fuel cell, a tubular solid oxide fuel cell, a protonic ceramic fuel cell, a direct carbon fuel cell, an enzymatic bio fuel cell, and a magnesium air fuel cell. In some embodiments, the fuel cell 204 can be configured to combust at least one of ethanol, hydrogen, methanol, ammonia, hydrazine, ethylene glycol, carbon monoxide, dilute methane, COS & H2S, phosphoric acid, cesium dihydrogen phosphate, cesium hydrogen sulfate, and formic acid.

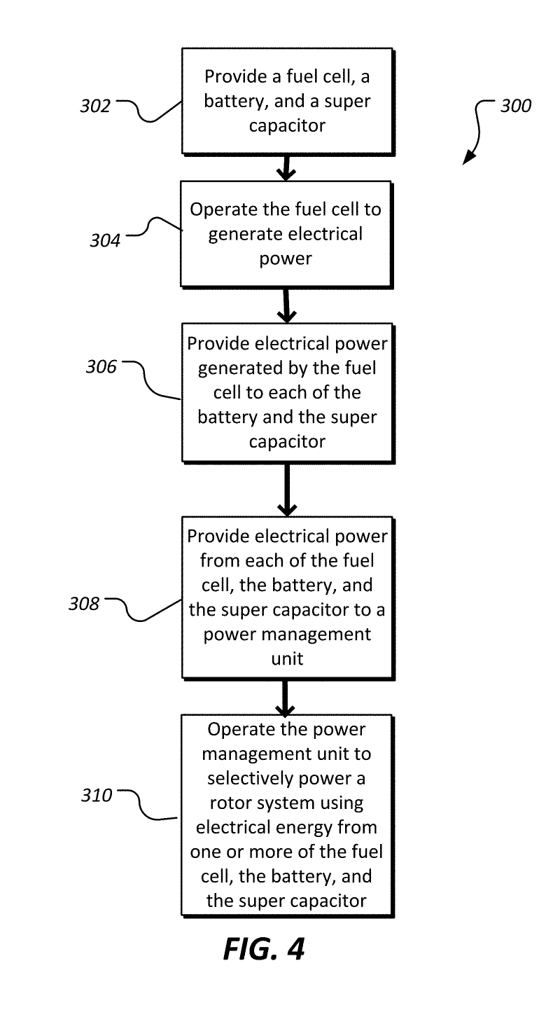

Referring now to FIG. 4, a method 300 of powering a rotor system of a rotorcraft is shown. The method 300 can begin at block 302 by providing a fuel cell, a battery, and a supercapacitor. Next, the method 300 can continue at block 304 by operating the fuel cell to generate electrical power. The method 300 can continue at block 306 by providing electrical power generated by the fuel cell to each of the battery and the supercapacitor. The method 300 can continue at block 308 by providing electrical power from each of the fuel cell, the battery, and the supercapacitor to a power management unit. The method 300 can continue at block 310 by operating the power management unit to selectively power a rotor system using electrical energy from one or more of the fuel cell, the battery, and the supercapacitor.

In some simulations of a helicopter comprising a power system 200, an increase in range and/or endurance has been predicted. Specifically, for a helicopter having a gross takeoff weight of 1669 kilograms, requiring a maximum power of 377 kW, a maximum continuous power of 342 kW, a cruise power of 264 kW, an endurance power of 245 kW, having fuel cell weighing 171 kg, a battery weighing 1.429 kg, and a supercapacitor weighing 3.485 kg (for a total power system weight of 517.18 kg), and having a payload limitation of 551.82 kg, it was predicted that the helicopter theoretical maximum endurance could be about 3.43 hours and the helicopter theoretical maximum range could be about 774.44 kilometers. In this simulation, it was determined that the required takeoff power is 360 kW and that during takeoff, the power management unit 206 can supply 342 kW from the fuel cell, 14.4 kW from the supercapacitor, and 3.6 kW from the battery. Similarly, it was determined that the required vertical climb power is 377 kW and that during vertical climbs, the power management unit 206 can supply 342 kW from the fuel cell, 28 kW from the supercapacitor, and 7 kW from the battery. Further, it was determined that the required cruise power is 245 kW and that during cruising, the power management unit 206 can supply 300 kW from the fuel cell for charging, the supercapacitor receives 44 kW for charging, and the battery receives 11 kW for charging. After completion of charging of each of the supercapacitor and the battery, it was determined that the fuel cell provides 245 kW while the supercapacitor and the battery provide no power. Substantially similar calculations to those given above with regard to helicopters can be carried out for any other aircraft and/or vehicle.

While the power system 200 described above is primarily discussed with regard to use with rotorcraft, it is contemplated that the power system 200 can be utilized in other vehicles (such as automobiles), specialized vehicles, and/or other power system energy storage applications.

At least one embodiment is disclosed and variations, combinations, and/or modifications of the embodiment(s) and/or features of the embodiment(s) made by a person having ordinary skill in the art are within the scope of the disclosure. Alternative embodiments that result from combining, integrating, and/or omitting features of the embodiment(s) are also within the scope of the disclosure. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). For example, whenever a numerical range with a lower limit, RI, and an upper limit, Rᵤ, is disclosed, any number falling within the range is specifically disclosed. In particular, the following numbers within the range are specifically disclosed: R=Rₗ+k*(Rᵤ−Rₗ), wherein k is a variable ranging from 1 percent to 100 percent with a 1 percent increment, i.e., k is 1 percent, 2 percent, 3 percent, 4 percent, 5 percent, . . . 50 percent, 51 percent, 52 percent, . . . , 95 percent, 96 percent, 97 percent, 98 percent, 99 percent, or 100 percent. Moreover, any numerical range defined by two R numbers as defined in the above is also specifically disclosed. Use of the term “optionally” with respect to any element of a claim means that the element is required, or alternatively, the element is not required, both alternatives being within the scope of the claim. Use of broader terms such as comprises, includes, and having should be understood to provide support for narrower terms such as consisting of, consisting essentially of, and comprised substantially of. Accordingly, the scope of protection is not limited by the description set out above but is defined by the claims that follow, that scope including all equivalents of the subject matter of the claims. Each and every claim is incorporated as further disclosure into the specification and the claims are embodiment(s) of the present invention.

What is claimed is:

1. An aircraft, comprising:
a fuel cell;
a battery configured to be charged by the fuel cell;
a supercapacitor configured to be charged by the fuel cell; and
a power management unit configured to receive electrical power from the fuel cell, the battery, and the supercapacitor.

2. The aircraft of claim 1, further comprising:
an electrical actuator comprising a motor configured to receive power from the power management unit.

3. The aircraft of claim 2, further comprising:
an at least partially electrically powered propulsion system.

4. The aircraft of claim 3, wherein the rotor system comprises a main rotor system or a plurality of rotors.

5. The aircraft of claim 3, wherein the rotor system is a tail rotor system.

6. The aircraft of claim 1, wherein the fuel cell is configured to substantially continuously provide operational electrical power output sufficient to power a rotor system.

7. The aircraft of claim 6, wherein the power management unit is configured to selectively direct electrical power that is unused by the rotor system to an electrically powered accessory.

8. The aircraft of claim 1, wherein the fuel cell comprises at least one of a microbial fuel cell, metal hydride fuel cell, electro-galvanic fuel cell, direct formic acid fuel cell, polymer membrane regenerative fuel cell, direct borohydride fuel cell, alkaline fuel cell, direct or reformed methanol fuel cell, direct ethanol fuel cell, proton exchange membrane fuel cell, redox fuel cell, phosphoric acid fuel cell, solid acid fuel cell, molten carbonate fuel cell, tubular solid oxide fuel cell, protonic ceramic fuel cell, direct carbon fuel cell, enzymatic bio fuel cell, and a magnesium air fuel cell.

9. The aircraft of claim 1, wherein the fuel cell is configured to combust at least one of ethanol, hydrogen, methanol, ammonia, hydrazine, ethylene glycol, carbon monoxide, dilute methane, COS & H2S, phosphoric acid, cesium dihydrogen phosphate, cesium hydrogen sulfate, and formic acid.

10. The aircraft of claim 1, wherein the battery comprises at least one of a lithium ion, lithium manganese oxide, zinc-carbon, zinc-chloride, alkaline, zinc manganese dioxide, nickel oxyhydroxide, lithium copper oxide, a bio-battery, lithium iron disulfide, lithium chromium oxide, lithium carbon fluoride, mercury oxide, zinc-air, silver-oxide, silver-zinc, magnesium, a Zamboni pile, nickel cadmium, nickel metal hydride, nickel zinc, silver zinc, lithium iron phosphate, and a solid state battery.

11. The aircraft of claim 1, wherein the supercapacitor comprises at least one of an electric double layer capacitor, a hybrid capacitor, a pseudo capacitor, a bio supercapacitor, and a fullerene supercapacitors, comprising at least one electrode comprising at least one of polyaniline, gold, aluminum, platinum, palladium, activated carbon, graphite, graphene, graphane, carbon nanotubes, carbide derived carbon, carbon aerogel, manganese, ruthenium, iridium, iron, titanium (sulfide), composite electrodes, lithium, sulfuric acid, potassium hydroxide, sodium perchlorate, lithium perchlorate, phosphonium salts, lithium hexafluoro arsenate, acetonitrile, propylene carbonate, polyacrylonitrile, chitin, lignin, pectin, cellulose, polymers of pyran, and furan.

12. A method of powering a rotor system of an aircraft, comprising:
providing a fuel cell, a battery, and a supercapacitor;
operating the fuel cell to generate electrical power;
providing electrical power generated by the fuel cell to each of the battery and/or the supercapacitor; and
powering a rotor system of an aircraft using electrical power generated by the fuel cell.

13. The method of claim 12, wherein the powering the rotor system comprises operating a brushless direct current motor or a permanent magnet synchronous motor.

14. The method of claim 12, wherein at least a portion of the electrical power used to power the rotor system is provided by the battery.

15. The method of claim 12, wherein at least a portion of the electrical power used to power the rotor system is provided by the supercapacitor.

16. The method of claim 12, further comprising:
providing a power management unit configured to receive electrical power from each of the fuel cell, the battery, and/or the supercapacitor and configured to provide electrical power used to power the rotor system.

17. The method of claim 16, wherein the power management unit is configured to selectively provide electrical power to an electric actuator.

18. The method of claim 17, wherein the electric actuator is configured to power a plurality of rotor systems.

19. The method of claim 12, wherein the fuel cell comprises an ethanol fueled fuel cell.

20. The method of claim 12, wherein the fuel cell comprises a nanoparticle catalyst.

21. The method of claim 12, wherein the fuel cell comprises an enzymatic biocatalyst.

22. The method of claim 12, wherein the fuel cell comprises at least one of a microbial fuel cell, metal hydride fuel cell, electro-galvanic fuel cell, direct formic acid fuel cell, polymer membrane regenerative fuel cell, direct borohydride fuel cell, alkaline fuel cell, direct or reformed methanol fuel cell, direct ethanol fuel cell, proton exchange membrane fuel cell, redox fuel cell, phosphoric acid fuel cell, solid acid fuel cell, molten carbonate fuel cell, tubular solid oxide fuel cell, protonic ceramic fuel cell, direct carbon fuel cell, enzymatic bio fuel cell, and a magnesium air fuel cell.
